(19) United States
(12) Patent Application Publication
(10) Pub. No.: US 2024/0193498 A1
(43) Pub. Date: Jun. 13, 2024

(54) METHOD FOR UPDATING WORKFLOWS ASSOCIATED WITH A USER

(71) Applicant: MOTOROLA SOLUTIONS, INC., Chicago, IL (US)

(72) Inventors: PATRICK YEE LEONG WONG, Simpang Ampat (MY); ROHAYA RAMLI, Abadi (MY); WAN SABRINA BINTI WAN SAFUAN, Kota Bharu (MY); WOOI PING TEOH, Georgetown (MY)

(21) Appl. No.: 18/064,430

(22) Filed: Dec. 12, 2022

(51) Int. Cl. G06Q 10/06; H04L 67/52

(52) U.S. Cl. CPC G06Q 10/06; H04L 67/52

(57) ABSTRACT

A process of updating workflows associated with a user based on a change in user's location. The workflow indicates that a trigger and a responsive action are respectively executed on a first physical device and a second physical device while the user is assigned to or physically present at a first location. The server detects that there is a change in user's location to a second location and responsively determines that a physical device selected from one of the first and second physical devices is no longer available for executing the workflow at the second location. The server identifies a third physical device capable of executing a workflow function previously executed by the selected physical device at the first location. The server then implements an updated workflow by replacing the selected physical device indicated in the workflow with the third physical device.

### BACKGROUND

Managing multiple devices within a security ecosystem can be a time-consuming and challenging task. This task typically requires an in-depth knowledge of each type of device within the security ecosystem in order to produce a desired workflow when a security event is detected. For example, consider a school system that employs a security ecosystem comprising a radio communication system, a video security system, and a door access control system. Assume that an administrator wishes to implement a first workflow that notifies particular radios if a door breach is detected. Assume that the administrator also wishes to implement a second workflow that also notifies the particular radios when a security camera detects loitering. In order to implement these two workflows, the access control system may have to be configured to provide the notifications to the radios and the video security system may have to be configured to provide the notifications to the radios. Thus, both the access control system and the video security system may need to be configured separately in order to implement the two workflows. As is evident, this requires the administrator to have an in-depth knowledge of both the video security system and the access control system. Thus, the lack of continuity across systems is a burden to administrators since an in-depth knowledge of all systems within the ecosystem may be needed in order to properly configure workflows within the ecosystem.

In order to reduce the burden on administrators and enhance their efficiency, a need exists for a user-friendly interface tool that gives administrators the ability to configure and automate workflows that control their integrated security ecosystem. It would also be beneficial if such a tool equips administrators with the capabilities they need to detect triggers across a number of installed devices/systems and quickly take actions (execute workflows) to reduce the risk of breaches and downtime by automatically alerting the appropriate teams and executing the proper procedures.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 illustrates a security ecosystem capable of configuring and automating workflows in accordance with some embodiments.

FIG. 2 illustrates a security ecosystem capable of configuring and automating workflows in accordance with some embodiments.

FIG. 3 illustrates a security ecosystem capable of configuring and automating workflows in accordance with some embodiments.

FIG. 4 illustrates a security ecosystem capable of configuring and automating workflows in accordance with some embodiments.

FIG. 5 illustrates a security ecosystem capable of configuring and automating workflows in accordance with some embodiments.

FIG. 6 is a block diagram of a workflow server of FIG. 1 in accordance with some embodiments.

FIG. 7 is a block diagram of a workstation of FIG. 1 utilized to generate a workflow in accordance with some embodiments.

FIG. 8 depicts a dashboard for generating a workflow in accordance with some embodiments.

FIG. 9 depicts the dashboard of FIG. 8 with an example workflow in accordance with some embodiments.

FIG. 10 depicts the dashboard of FIG. 8 with other example workflows in accordance with some embodiments.

FIG. 11 is a flowchart of a process for updating workflows associated with a user in accordance with some embodiments.

FIG. 12 illustrates an example scenario in which a workflow associated with a user is updated in response to a change in the user's location from a first location to a second location.

FIG. 13A depicts a dashboard illustrating example workflows associated with the user at a first location.

FIG. 13B depicts a dashboard illustrating updates made to workflows associated with the user based on a change in the user's location from the first location to a second location.

FIG. 14 illustrates another example scenario in which a workflow associated with a user is updated in response to a change in the user's location from a first location to a second location.

FIG. 15A depicts a dashboard illustrating example workflows associated with the user at a first location.

FIG. 15B depicts a dashboard illustrating updates made to workflows associated with the user based on a change in the user's location from the first location to a second location.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In order to address the above-mentioned need, a system, method, and apparatus for implementing and updating workflows associated with users across multiple differing systems and devices is provided herein. During operation a workflow is automatically generated upon the detection of new device capabilities. In particular, a workflow server will detect the presence of new device capabilities in a particular area. The new device capabilities will be analyzed, and an appropriate trigger and action will be determined based on the new device capabilities. The appropriate trigger and action will then be suggested or implemented as a newly-created workflow.

As an example, security officers stationed at a given location may have physical devices assigned to them for executing certain workflows associated with the officer's job to reduce security breaches and downtime by automatically alerting them. Such physical devices include sensors (e.g., cameras, motion sensors, temperature sensors, vibration sensors, etc.,) that are configured to detect security triggers. Such physical devices also include effectors (e.g., floodlights, radios, speakers, sirens, displays, etc.,) that are configured to take actions in response to the detected triggers. Conventionally, such physical devices including sensors and effectors are assigned to users (e.g., first responders, police officers, security guards etc.,) manually by administrators who may create one or more security workflows and associate them to the users based on the physical devices assigned to the users according to the user's current location. However, when the user is assigned to (or when the user physically moves to) a new location (e.g., to monitor security situations at the new location), the physical devices assigned to the user for executing workflows at the previous location may no longer be available for execution at the new location. In such situations, administrators may have to manually identify and re-assign physical devices (i.e., sensors and effectors) available at the officer's new location and further re-create or update previously created workflows for the user for execution at the new location according to the physical devices re-assigned to the officer at the new location. If user's assigned locations tend to change a lot or the organization employing the users implements a flexible or dynamic assignment of locations to users, it would be inconvenient for administrators to manually create or update workflows for the users each time there is a change in the user's assigned location. Thus, there also exists a need for an improved technical system, device, and system for updating workflows associated with a user automatically in response to a change in the user's location.

One embodiment provides a method of updating workflows associated with a user. The method includes: maintaining, at a workflow server, a workflow associated with the user, the workflow indicating that a trigger and a responsive action are respectively executed on a first physical device and a second physical device while the user is assigned to or physically present at a first location; detecting, at the workflow server, that the user has been assigned to or physically present at a second location different from the first location and responsively determining that a physical device selected from one of the first physical device and the second physical device is no longer available for executing the workflow associated with the user at the second location; identifying, at the workflow server, a third physical device that is (i) available to be assigned to the user for execution of the workflow associated with the user at the second location and (ii) capable of executing a workflow function at the second location, the workflow function corresponding to one of the trigger or responsive action executed by the selected physical device at the first location; updating, at the workflow server, the workflow associated with the user by replacing the selected physical device indicated in the workflow with the third physical device; and implement, at the workflow server, the updated workflow by transmitting a command instructing the third physical device to execute the workflow function corresponding to the one of the trigger or responsive action at the second location.

Another embodiment provides an electronic computing device, comprising a communications unit and an electronic processor communicatively coupled to the communications unit. The electronic processor is configured to: a memory; a communications interface; and an electronic processor communicatively coupled to the memory and the communications interface, the electronic processor configured to: maintain, at a memory, a workflow associated with the user, the workflow indicating that a trigger and a responsive action are respectively executed by a first physical device and a second physical device while the user is assigned to or physically present at a first location; detect that the user has been assigned to or physically present at a second location different from the first location and responsively determining that a physical device selected from one of the first physical device and the second physical devices is no longer available for executing the workflow associated with the user at the second location; identify a third physical device that is (i) available to be assigned to the user for execution of the workflow associated with the user at the second location and (ii) capable of executing a workflow function at the second location, the workflow function corresponding to one of the trigger or responsive action executed by the selected physical device at the first location; update the workflow associated with the user by replacing the selected physical device indicated in the workflow with the third physical device; and implement the updated workflow by transmitting, via the communications interface, a command instructing the third physical device to execute the workflow function corresponding to the one of the trigger or responsive action at the second location.

Each of the above-mentioned embodiments will be discussed in more detail below, starting with example system and device architectures of the system in which the embodiments may be practiced, followed by an illustration of processing blocks for achieving an improved technical method, device, and system for updating workflows associated with a user.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

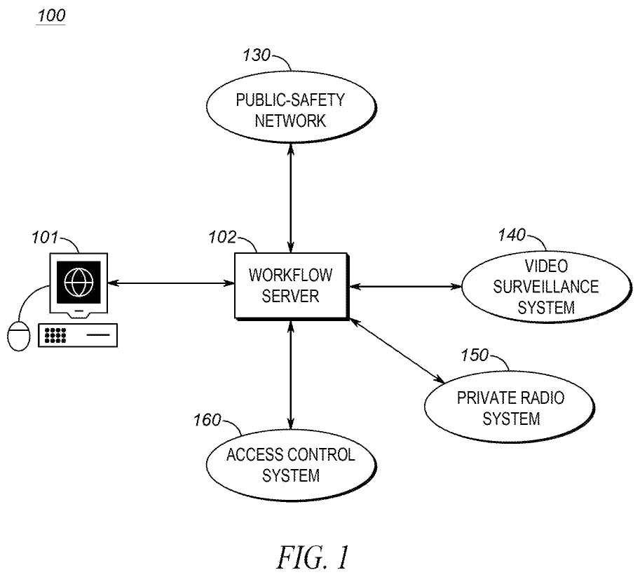

Further advantages and features consistent with this disclosure will be set forth in the following detailed description, with reference to the figures. Turning now to the drawings, wherein like numerals designate like components, FIG. 1 illustrates a security ecosystem 100 capable of configuring and automating workflows across multiple systems. The security ecosystem 100 is interchangeably referred to hereafter as the system 100. Furthermore, workflows as referred herein may alternatively be referred as security workflows or workflows that may be used to implement security-based action and/or security based processes.

The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

As shown, the security ecosystem 100 comprises a public-safety network 130, a video surveillance system 140, a private radio system 150, and an access control system 160. The workflow server 102 is coupled to each system 130, 140, 150, and 160. The workstation 101 is shown coupled to the workflow server 102, and is utilized to configure the workflow server 102 with workflows, for example as generated by a user. It should be noted that although the components in FIG. 1 are shown geographically separated, these components can exist within a same geographic area, such as, but not limited to a school, a hospital, an airport, a sporting event, a stadium, a factory, a warehouse and/or any other suitable location and/or building and the like. It should also be noted that although only networks and systems 130, 140, 150, 160 are shown in FIG. 1, many more networks and/or systems may be included in the security ecosystem 100 and/or any suitable number of networks and/or systems may be included in the security ecosystem 100.

The workstation 101 may comprise a computer configured to execute Motorola Solution's Orchestrate™ and Ally™ dispatch and incident management software. As will be discussed in more detail below, the workstation 101 is configured to present a user with a plurality of triggers capable of being detected by the network and systems 130, 140, 150, 160 as well as present the user with a plurality of actions capable of being executed by the network and systems 130, 140, 150, 160. The user will be able to create workflows and upload these workflows to the workflow server 102 based on the presented triggers and actions. While only one workstation 101 is shown, the system 100 may comprise a plurality of workstations 101.

The workflow server 102 may comprise a server running Motorola Solution's Command Central™ software suite comprising the Orchestrate™ platform. While the workflow server 102 is depicted as one device, the workflow server 102 may be implemented as one or more computing devices, servers, one or more cloud computing devices, and the like, and/or the functionality of the workflow server 102 may be geographically distributed. The workflow server 102 is configured to receive workflows created by the workstation 101 and implement the workflows. Particularly, the workflows are implemented by analyzing events detected by the network and systems 130, 140, 150, 160 and executing appropriate triggers. In a particular example, a user may create a workflow on the workstation 101 that has a trigger comprising the video surveillance system 140 detecting a loitering event, and has a responsive action comprising notifying radios within the public-safety network 130. When this workflow is uploaded to the workflow server 102, the workflow server 102 will notify the radios of any loitering event detected by the video surveillance system 140.

The public-safety network 130 is configured to detect various triggers and report the detected triggers to the workflow server 102. The public-safety network 130 is also configured to receive action commands from the workflow server 102 and execute the actions. In some examples, the public-safety network 130 comprises includes typical radio-access network (RAN) elements such as base stations, base station controllers (BSCs), routers, switches, and the like, arranged, connected, and programmed to provide wireless service to user equipment, report detected events, and execute actions received from the workflow server 102.

The video surveillance system 140 is configured to detect various triggers and report the detected triggers to the workflow server 102. The video surveillance system 140 is also configured to receive action commands from the workflow server 102 and execute the actions. In one example, the video surveillance system 140 comprises a plurality of video cameras that may be configured to automatically change their field of views over time. The video surveillance system 140 is configured with a recognition engine/video analysis engine (VAE) that comprises a software engine that analyzes any video captured by the cameras using, for example, any suitable process, which may include, but is not limited to machine learning algorithms, convolutional neural networks, and the like. Using the VAE, the video surveillance system 140 is capable of “watching” video to detect any triggers and report the detected triggers to the workflow server 102. These triggers may include, but are not limited to, appearance searches and unusual Activity Detection (e.g., loitering). In a similar manner, the video surveillance system 140 is configured to execute action commands received from the workflow server 102. In some examples, the video surveillance system 140 comprises an Avigilon™ Control Center (ACC) server having Motorola Solution's Access Control Management (ACM)™ software suite.

The private radio system 150 may comprise a private enterprise radio system that is configured to detect various triggers and report the detected triggers to the workflow server 102. The private radio system 150 is also configured to receive action commands from the workflow server 102 and execute the actions. In some examples, the private radio system 150 comprises a MOTOTRBO™ communication system having radio devices that operate in the Citizens Broadband Radio Service (CBRS) spectrum and combines broadband data with voice communications.

The access control system 160 comprises an Internet-of-Things (IOT) network which may serve to connect every-day devices to the Internet. Devices such as cars, kitchen appliances, medical devices, sensors, doors, windows, HVAC (heating, ventilation, and air conditioning) systems, drones, . . . , etc. can all be connected through the IoT network of the access control system 160. Indeed, any suitable device that can be powered may be connected to the internet to control its functionality. The access control system 160 generally allows objects to be sensed or controlled remotely across existing network infrastructure. For example, the access control system 160 may be configured to provide access control to various doors and windows. In particular, the access control system 160 is configured to detect various triggers (e.g., door opened/closed) and report the detected triggers to the workflow server 102. The access control system 160 is also configured to receive action commands from the workflow server 102 and execute the action received from the workflow server 102. The action commands may take the form of instructions to lock, open, and/or close a door or window.

As is evident, the security ecosystem 100 allows an administrator using the workstation 101 to create rule-based, automated workflows between technologies to enhance efficiency, and improve response times, effectiveness, and overall safety. The security ecosystem 100 has the capability to detect triggers across a number of physical devices or sensors implemented within the system 100. When one or more triggers are detected, systems 130, 140, 150, 160 quickly take actions by automatically executing the proper procedure, for example, by executing an appropriation action via a number of physical devices or effectors implemented within the system).

The network and systems 130, 140, 150, 160 are next described in further detail.

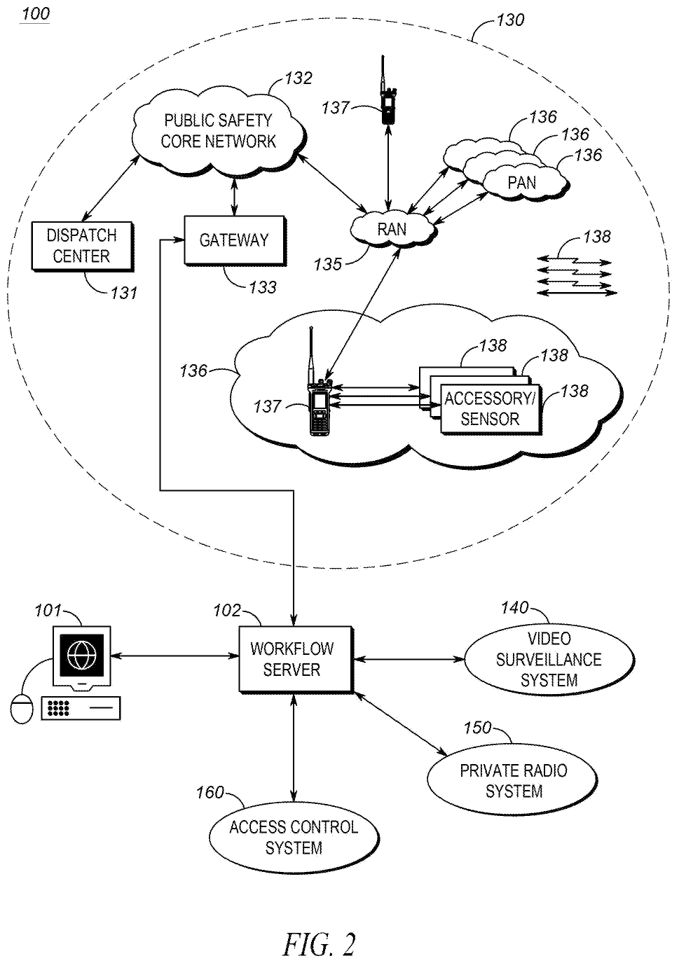

FIG. 2 illustrates a security ecosystem capable of configuring and automating workflows. In particular, FIG. 2 shows the security ecosystem 100 with an expanded view of the public-safety network 130. As shown, the public-safety network 130 comprises a dispatch center 131, a public-safety core network 132, a gateway 133, a radio access network (RAN) 135, a plurality of personal-area networks (PANs) 136, and at least radio 137, such as a public-safety radio and the like. The at least one radio 137 may also include, but is not limited to, any suitable combination of communication devices, such as mobile phones, two-way radios, and the like. As shown, each PAN 136 comprises a physical device such as a radio 137 acting as a hub to smart devices/accessories/sensor 138 (interchangeably referred to hereafter as the physical devices, the sensors and/or a sensor 138).

The gateway 133 may comprise an Avigilon™ Control Center running Avigilon's Access Control Management software. The gateway 133 is configured to run any suitable Application Program Interface (API) to provide communications between the public-safety core network 132 and the workflow server 102.

A public safety officer (not shown in FIG. 2) may be equipped with or assigned to physical devices or sensors 138 that determine various physical and environmental conditions surrounding the public-safety officer. These conditions may be reported back to, for example, the dispatch center 131 or the workflow server 102 so an appropriate action may be taken. For example, police officers may have a sensor 138 (e.g. in the form of a gun-draw sensor) that determines when a gun is drawn. Upon detecting that an officer has drawn their gun, a notification may be sent back to the dispatch operator and/or the workflow server 102 so that, for example, other officers in the area may be notified of the situation.

It is envisioned that the public-safety officer may have an array of these physical devices or sensors 138 available to the officer at the beginning of a shift. The officer may select and pull sensors 138 off a shelf, and form a personal-area network (PAN) 136 with the devices that may accompany the officer on their shift. For example, the officer may pull a gun-draw sensor, a body-worn camera, a wireless microphone, a smart watch, a police radio, smart handcuffs, a man-down sensor, a bio-sensor, and the like. All sensors 138 pulled by the officer may be configured to form a PAN 136 by associating (pairing) with each other and communicating wirelessly among the devices. At least one device may be configured with a digital assistant. In some examples, a PAN 136 comprises more than two sensors 138, so that many sensors 138 may be connected via a PAN 136 simultaneously.

A method called bonding may be used for recognizing specific sensors 138 and thus enabling control over which accessories are allowed to connect to each other when forming a PAN 136. Once bonded, accessories then can establish a connection without user intervention. A bond may be created through a process called “pairing”. The pairing process may be triggered by a specific request by the user to create a bond from a user via a user interface on the accessories. Thus, as shown, public-safety network 130 incorporates PANs 136 created as described above. In some examples, radios 137 and sensors 138 form a PAN 136, with communication links between sensors 138 and radios 137 taking place utilizing a short-range communication system protocol such as a Bluetooth communication system protocol. In this particular example, a PAN 136 may be associated with a single officer. Thus, FIG. 2 illustrates multiple PANs 136 associated with multiple officers (not shown).

The RAN 135 may include various RAN elements such as base stations, base station controllers (BSCs), routers, switches, and the like, arranged, connected, and programmed to provide wireless service to user equipment (e.g., the radios 137, and the like) in a manner known to those of skill in the relevant art. The RAN 135 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other examples, the RAN 135 may implement a Long Term Evolution (LTE), LTE-Advance, or 5G protocol including multimedia broadcast multicast services (MBMS) or single site point-to-multipoint (SC-PTM) (including, but not limited to open mobile alliance (OMA) push to talk (PTT) over cellular (OMA-PoC)), a voice over IP (VOIP), an LTE Direct or LTE Device to Device, or a PTT over IP (PoIP) application may be implemented. In still further examples, the RAN 135 may implement a Wi-Fi protocol for example operating in accordance with an IEEE 802.11 standard (e.g., 802.11a, 802.11b, 802.11g) or a WiMAX protocol for example operating in accordance with an IEEE 802.16 standard.

The public-safety core network 132 may include one or more packet-switched networks and/or one or more circuit-switched networks, and in general provides one or more public-safety agencies with any suitable computing and communication needs, transmitting any suitable public-safety-related data and communications.

For narrowband LMR wireless systems, the public-safety core network 132 may operate in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some examples, group IDs (identifiers) may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between radios 137 and other devices via wireless transmissions in accordance with either a narrowband or a broadband protocol or standard. Group members for group calls may be statically or dynamically defined. That is, in a first example, a user or administrator may indicate to the switching and/or radio network (such as at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) c based on user input, and the switching and/or radio network may track group membership and route new group calls according to the current group membership.

The radios 137 generally serve as PAN main devices, and may be any suitable computing and communication device configured to engage in wireless communication with the RAN 135 over the air interface as is known to those in the relevant art. Moreover, one or more radios 137 are further configured to engage in wired and/or wireless communication with one or more local sensors 138 via a local communication link. The radios 137 may be configured to determine when to forward information received from PA sensors 138 to, for example, a dispatch center or the workflow server 102.

Some examples of physical devices or sensors 138 follow:

In some examples, a sensor 138 may comprise a sensor-enabled holster that maintains and/or provides state information regarding a weapon or other item normally disposed within the user's sensor-enabled holster. The sensor-enabled holster may detect a change in state (presence to absence) and/or an action (removal) relative to the weapon normally disposed within the sensor-enabled holster. The detected change in state and/or action may be reported to a radio 137 via its short-range transceiver, which may forward the state change to the dispatch center 131 or the workflow server 102. In some examples, the sensor-enabled holster may also detect whether the first responder's hand is resting on the weapon even if it has not yet been removed from the holster and provide such information to portable radio 137.

In some examples, a sensor 138 may comprise a biometric sensor (e.g., a biometric wristband) for tracking an activity of the user or a health status of a user, and may include one or more movement sensors (such as an accelerometer, magnetometer, and/or gyroscope) that may periodically or intermittently provide to a radio 137 indications of orientation, direction, steps, acceleration, and/or speed, and indications of health such as one or more of a captured heart rate, a captured breathing rate, and a captured body temperature of the user, for example accompanying other information. This information may be reported to a radio 137 which may forward the information to the dispatch center 131 and/or the workflow server 102.

In some examples, a sensor 138 may comprise an accelerometer to measure acceleration. Single and multi-axis models are available to detect magnitude and direction of the acceleration as a vector quantity, and may be used to sense orientation, acceleration, vibration shock, and falling. The accelerometer may determine if an officer is running. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing. This information may be reported to a radio 137 which may forward the information to dispatch center 131 and/or the workflow server 102.

In some examples, a sensor 138 may comprise a heart rate sensor that uses electrical contacts with the skin to monitor an electrocardiography (EKG) signal of its wearer, or may use infrared light and imaging device to optically detect a pulse rate of its wearer, among other possibilities. This information may be reported to a radio 137 which may forward the information to the dispatch center 131 and/or the workflow server 102.

In some examples, a sensor 138 may comprise a breathing rate sensor 138 to monitor breathing rate. The breathing rate sensor may include use of a differential capacitive circuits or capacitive transducers to measure chest displacement and thus breathing rates. In other examples, a breathing sensor may monitor a periodicity of mouth and/or nose-exhaled air (e.g., using a humidity sensor, temperature sensor, capnometer or spirometer) to detect a respiration rate. Other possibilities exist as well. This information may be reported to a radio 137 which may forward the information to the dispatch center 131 and/or the workflow server 102.

The dispatch center 131 may comprise, and/or may be part of, a computer-aided-dispatch center (sometimes referred to as an emergency-call center or public-safety answering point), that may be manned by an operator providing any suitable dispatch operations. For example, the dispatch center 131 may comprise a graphical user interface that provides the dispatch operator any suitable information about public-safety officers. As discussed above, some of this information originates from sensors 138 providing information to radios 137, which forwards the information to the RAN 135 and ultimately to the dispatch center 131.

In a similar manner, information about public-safety officers may be provided to the workflow server 102. This information may originate from the sensors 138 providing information to the radios 137, which forwards the information to the RAN 135 and ultimately to the workflow server 102 via the public-safety core network 132 and the gateway 133. For example, a sensor 138 comprising a gun-draw sensor may send an indication to the workflow server 102 that a gun has been drawn. This may serve as a “trigger” for the workflow server 102 to initiate a particular “action”, for example, notifying surrounding officers (for example on a particular talkgroup) by having their radios 137 provide an alarm indicating the triggering event. Thus, the workflow server 102 may provide instructions to any sensor 138 or radio 137 by sending an “action” to a sensor 138 in response to a trigger being received.

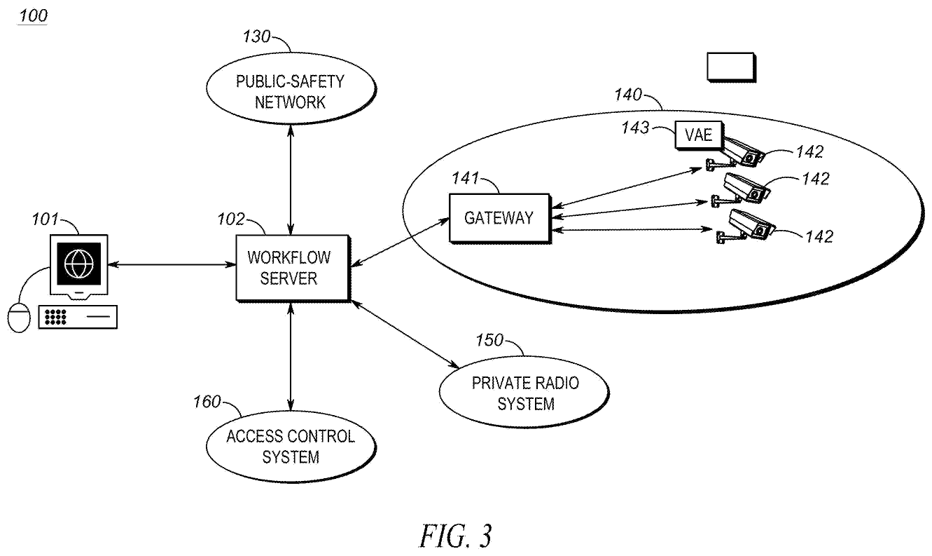

FIG. 3 illustrates a security ecosystem capable of configuring and automating workflows. In particular, FIG. 3 shows the security ecosystem 100 with an expanded view of the video surveillance system 140. As shown, the video surveillance system 140 comprises a plurality of physical devices such as image sensors and/or cameras 142 and the gateway 141.

Cameras 142 may be fixed or mobile, and may have pan/tilt/zoom (PTZ) capabilities to change their field of view. The cameras 142 are generally understood to comprise image sensors and hence may also be referred to as images sensors. Cameras 142 may also comprise circuitry configured to serve as a VAE 143 (only one of which is depicted in FIG. 3, though it is understood that any camera 142 may comprise circuitry configured to serve as a VAE 143). The VAE 143 comprises a software engine that analyzes analog and/or digital video. The engine configured to “watch” video and detect pre-selected objects such as license plates, people, faces, automobiles. The software engine may also be configured to detect certain actions of individuals, such as fighting, loitering, crimes being committed, . . . , etc. The VAE 143 may contain any of several object/action detectors. Each object/action detector “watches” the video for a particular type of object or action. Object and action detectors can be mixed and matched depending upon what is trying to be detected. For example, an automobile object detector may be utilized to detect automobiles, while a fire detector may be utilized to detect fires.

The gateway 141 may comprise an Avigilon™ Center running Avigilon's Access Control Management software. The gateway 141 is configured to run any suitable Application Program Interface (API) to provide communications between any cameras 142 and the workflow server 102.

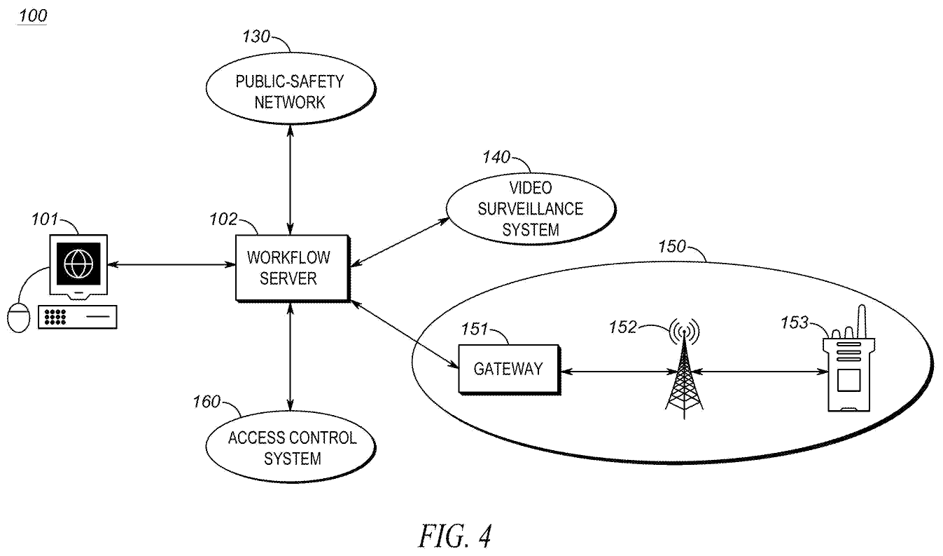

FIG. 4 illustrates a security ecosystem capable of configuring and automating workflows. In particular, FIG. 4 shows the security ecosystem 100 with an expanded view of the private radio system 150. As shown, the private radio system 150 comprises the gateway 151, system infrastructure 152, and at least one physical device such as a radio 153. Communications from the radio 153 to the workflow server 102 passes through the system infrastructure 152, the gateway 151, and ultimately to the workflow server 102.

The gateway 151 may comprise an Avigilon™ Control Center running Avigilon's Access Control Management software. The gateway 151 is configured to run any suitable Application Program Interface (API) to provide communications between any of the system infrastructure 152 and the workflow server 102.

The system infrastructure 152 comprises any suitable equipment to provide wireless communications to and from the radio 153. The system infrastructure 152 may comprise Motorola Solutions MOTOTRBO™ equipment, such as an SLR Series Repeater (e.g., SLR 1000, SLR 5000, or SLR8000 repeater) configured to provide two-way radio service to radio 153.

Although only a single radio 153 is shown in FIG. 4, any suitable number of radios 153 may be present within the private radio system 150. Each radio 153 may comprise a MOTOTRBO™ two-way radio (such as a Motorola Solution XPR 5000 Series radio) with digital technology providing integrated voice and data communication.

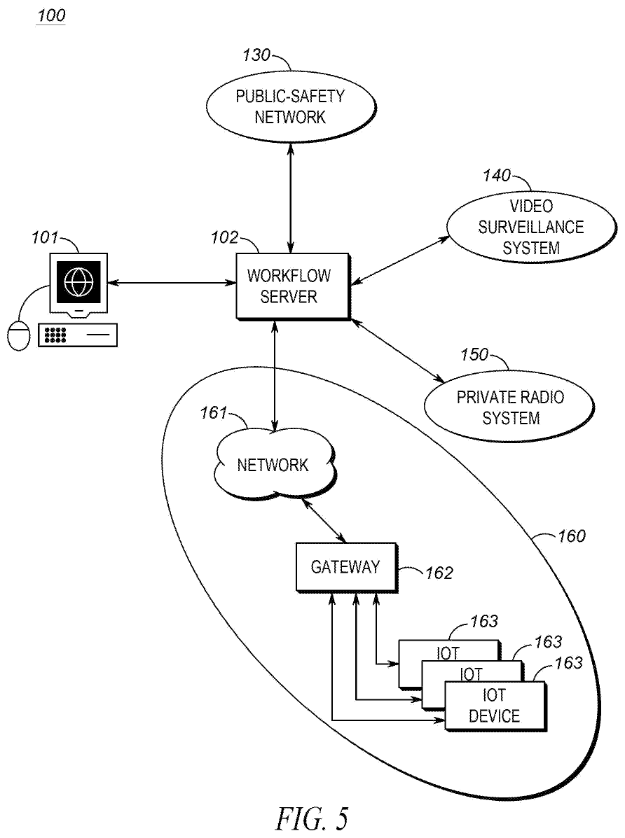

FIG. 5 illustrates a security ecosystem capable of configuring and automating workflows. In particular, FIG. 5 shows the security ecosystem 100 with an expanded view of the access control system 160. As shown, the access control system 160 comprises a gateway 162 and a plurality of physical devices such as IoT devices 163 coupled to the gateway 162. Data passed from the workflow server 102 to the IoT devices 163 passes through the network 161, the gateway 162 and ultimately to the IoT device 163. Conversely, data passed from the IoT devices 163 to the workflow server 102 passes through the gateway 162, the network 161, and ultimately to the workflow server 102.

The IoT devices 163 may comprise physical devices that control objects, doors, windows, sensors, and the like. Any particular suitable communication protocol (e.g. an IoT protocol) may be used for each IoT device. For example, various proprietary protocols such as DNP, Various IEC**** protocols (IEC 61850 etc. . . . ), bacnet, EtherCat, CANOpen, Modbus/Modbus TCP, EtherNet/IP, PROFIBUS, PROFINET, DeviceNet, . . . , etc. can be used. Also a more generic protocol such as Coap, Mqtt, and RESTfull may also be used.

The gateway 162 may comprise an Avigilon™ Control Center running Avigilon's Access Control Management software. The gateway 162 is configured to run any suitable Application Program Interface (API) to provide communications between any IoT device 163 and the workflow server 102.

The network 161 may comprise one of many networks used to transmit data, including, but not limited to, a network employing one of the following protocols: conventional, or trunked LMR standard or protocol such as ETSIDMR, a 25 standard defined by the APCO, TETRA, or other LMR radio protocols or standards; LTE protocol, LTE-Advance protocol, or 5G protocol including multimedia broadcast MBMS or SC-PTM protocol (including, but not limited to an OMA-PTT OMA-PoC), a VoIP protocol, an LTE Direct or LTE Device to Device protocol, or a PoIP protocol, a Wi-Fi protocol for example operating in accordance with an IEEE 802.11 standard (e.g., 802.11a, 802.11b, 802.11g) or a WiMAX protocol for example operating in accordance with an IEEE 802.16 standard.

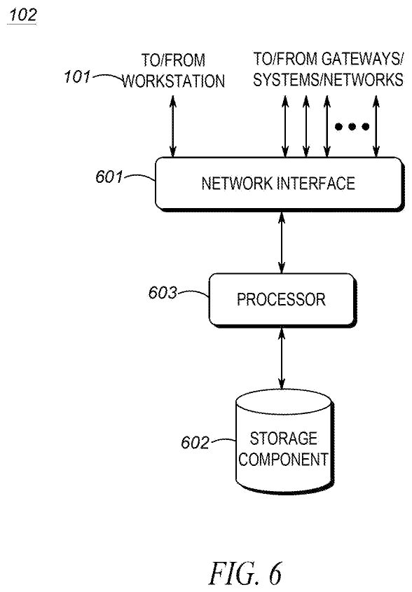

FIG. 6 is a block diagram of the workflow server 102 of FIG. 1. As shown, the workflow server 102 comprises a network interface 601, a storage component 602 (e.g. as depicted a database, but may comprise any suitable memory and/or storage component), and an electronic processor 603. The electronic processor 603 is understood to include any suitable logic circuitry.

The network interface 601 includes any suitable components for communicating with other suitable components of the system 100, in particular, as depicted, to the workstation 101, the gateways 133, 141, 151, 162 of the networks and systems 130, 140, 150, 160, and the like. Components of the network interface 601 include any suitable processing, modulating, and transceiver components that are operable in accordance with any one or more standard or proprietary wireless interfaces, wherein some of the functionality of the processing, modulating, and transceiver components may be performed by means of the processor 603 through programmed logic such as software applications or firmware stored on the storage component 602 (e.g., standard random access memory) or through hardware. The network interface 601 may include any suitable wired or wireless network interfaces, including, but not limited to, Ethernet interfaces. T1 interfaces, USB interfaces, IEEE 802.11b interfaces, IEEE 802.11g interfaces, and the like.

The processor 603 may comprise a digital signal processor (DSP), general purpose microprocessor, a programmable logic device, or application specific integrated circuit (ASIC), and the like, and is generally configured to receive triggers from various gateways, systems, and networks (e.g. of the system 100). The processor 603 is further configured to execute (or cause to be executed) a particular action for a trigger that is received. More particularly, when the processor 603 receives a trigger from any network or system, the processor 603 may access the storage component 602 to determine an action for the particular trigger. Once an action has been determined, the processor 603 will execute the action, or cause the action to be executed. In order to perform the above, the processor 603 may executes an instruction set/software (e.g., Motorola Solution's Command Central™ software suite comprising the Orchestrate™ platform) which may be stored at the storage component 602.

The storage component 602 may comprises standard memory (such as Random Access Memory (RAM), Read Only Memory (ROM), and the like) and serves to store associations between triggers and actions. Examples of various triggers and actions are illustrated in Table 1, below.

TABLE 1
Associations Between Triggers and Actions.

| Trigger | Action |
|---|---|
| Warehouse back door opened | Pan camera “342” to point at door |
| Man-Down sensor activated for | Notify dispatch center via emergency |
| Officer Smith | text message |
| ALPR for delivery truck | Open back gate |
| . . . etc. | . . . etc. |

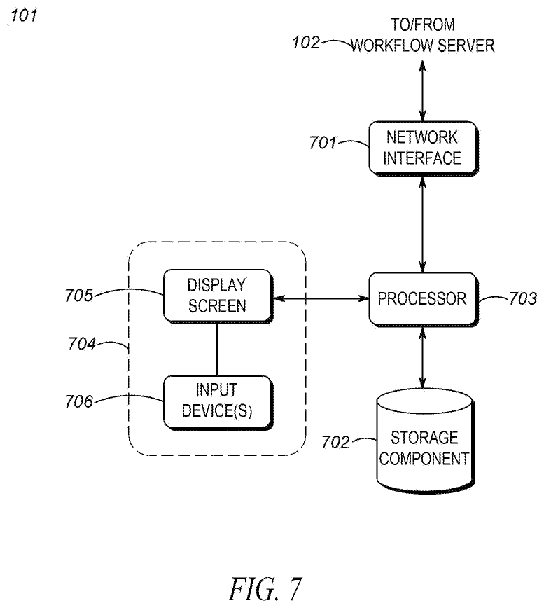

FIG. 7 is a block diagram of the workstation 101 of FIG. 1 utilized to create a workflow. As shown, the workstation 101 comprises a network interface 701, a storage component 702, a processor 703, and a graphical user interface (GUI) 704.

The network interface 701 includes any suitable components for communicating with other suitable components of the system 100, in particular, as depicted, to the workflow server 102. Components of the network interface 701 include any suitable processing, modulating, and transceiver components that are operable in accordance with any one or more standard or proprietary wireless interfaces, wherein some of the functionality of the processing, modulating, and transceiver components may be performed by means of the processor 703 through programmed logic such as software applications or firmware stored on the storage component 702 (e.g., standard random access memory) or through hardware. The network interface 701 may include any suitable wired or wireless network interfaces, including, but not limited to, Ethernet interfaces, T1 interfaces, USB interfaces, IEEE 802.11b interfaces, IEEE 802.11g interfaces, and the like.

Processor 703 may comprise a DSP), general purpose microprocessor, a programmable logic device, or an ASIC and may be configured to execute Motorola Solution's Orchestrate™ and Ally™ dispatch and incident management software which may be stored at the storage component 702. The execution of such software may allow users of the GUI 704 to create workflows (i.e., actions and their associated responses) by receiving user inputs at the GUI 704 that define various triggers and their associated actions, which will ultimately be uploaded to the workflow server 102 and stored in the storage component 602.

The storage component 702 may comprise standard memory (such as RAM, ROM, and the like) and serves to store instructions as software. Particularly, Motorola Solution's Orchestrate™ and Ally™ dispatch and incident management software may be stored at the storage component 702.

The GUI 704 generally provides a man/machine interface for receiving an input from a user and displaying information. For example, the GUI 704 may provide a mechanism of conveying (e.g., displaying) user-created workflows. Thus, the GUI 704 may also provide a mechanism for a user to input workflows into a displayed form. In order to provide the above features (and additional features), the GUI 704 may include any combination of a display screen 705 (e.g., a computer screen, which may include a touch screen, a monitor, and the like) and any suitable combination of one or more input devices 706 (e.g. a keyboard and mouse combination).

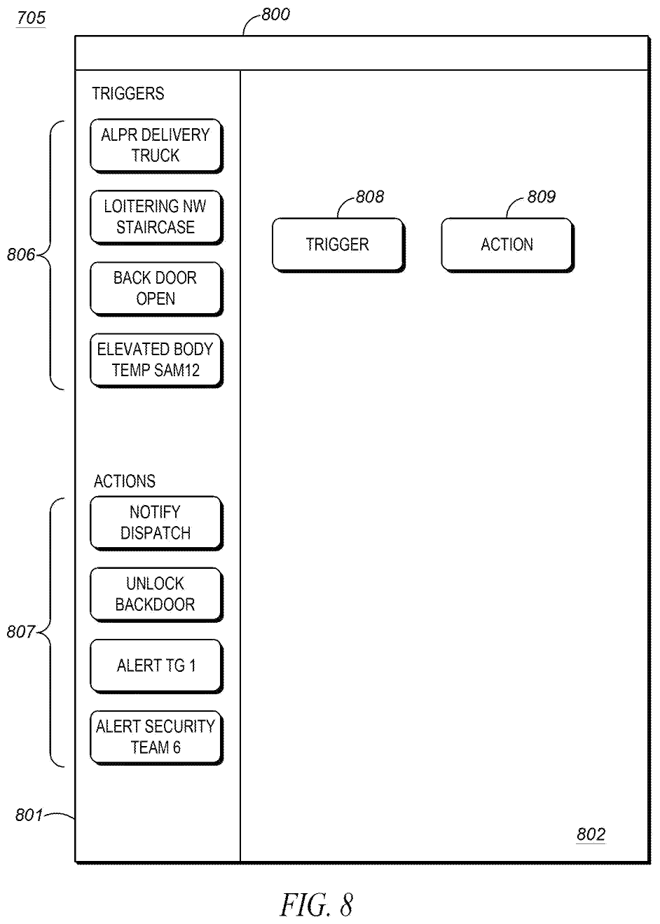

FIG. 8 illustrates the generation of a workflow. More particularly, FIG. 8 illustrates a dashboard 800 rendered at the display screen 705 utilized for the creation and/or approval of workflows. As depicted, the dashboard 800 consists of the following main components: a selection panel 801 (e.g. on a left-hand side), which lists available triggers 806 and actions 807; and a workflow space or workspace 802, which comprises a large area in the middle of the dashboard 800 used to create workflows that define the connections between triggers and responsive actions. Each workflow in the workspace 802 is displayed as a separate field 808, 809 with an outline and a title. As shown in FIG. 8, two fields 808, 809 are shown, one labeled “trigger” and another labeled “action”.

While the dashboard 800 is depicted in a particular configuration, the dashboard 800 may have any suitable configuration; for example, the selection panel 801 may be on a right-hand side, a top side or a bottom side relative to the workspace 802.

The triggers 806 represent the events originating from various sensors, software, and devices within the security ecosystem 100. The actions 807 represent the possible responses to the triggers that may be implemented via any suitable physical devices including sensors, softwares, and devices within the security ecosystem 100, including, but not limited to, the radios 137, 153.

After a workflow is deployed (i.e., uploaded to the workflow server 102), its actions activate when the triggers occur. Triggers and actions appear on the workspace 802 after they are dragged and dropped from the triggers 806 and actions 807 tabs respectively. For example, as depicted, the field 808 represents a trigger 806 that may have been dragged and dropped to the workspace 802 and the field 809 represents an action 807 that may have been dragged and dropped to the workspace 802. Connecting the triggers and actions on the workspace 802 (as described below) will generate a workflow.

The triggers 806 and the actions 807 are generally stored at the storage component 702 and represent integrations across multiple products. In other words, triggers 806 and the actions 807 comprise triggers and actions for any suitable components available in the security ecosystem 100. This includes cameras, sensors, IoT devices, radios, . . . , etc. As administrators add additional technology pieces to the security ecosystem 100, those pieces may be automatically made available for workflow creation as discussed herein.

In order to associate a trigger 806 with an action 807 in the workspace 802, a user selects a trigger 806 from all possible triggers 806, and drags and drops it onto workspace 802, as represented by the field 808. The user then selects an action 807 for the trigger 806 that is in the workspace 802, and drags and drops it onto workspace 802. Once in the workspace 802, a trigger 806 may be referred to as a trigger node, and an action 807 may be referred to as an action node. In order to associate the trigger 806 with the action 807, they are connected. To connect a trigger node to an action node, a user may click an end of the trigger node (e.g. that is closest to the action node) and drag a line to the action node, or vice versa. However, any suitable process for connecting nodes is within the scope of the present specification.

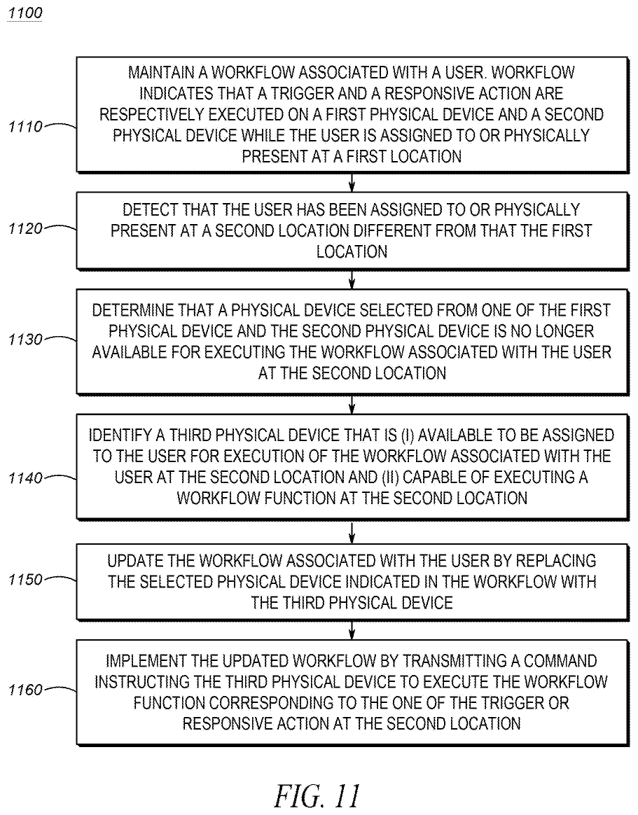

In accordance with some embodiments, a workflow associated with a user, where the workflow indicates a trigger 806 and a responsive action 807, may be automatically generated or updated in the workspace 802 in response to a change in the user's location as further described with reference to FIGS. 11-15.

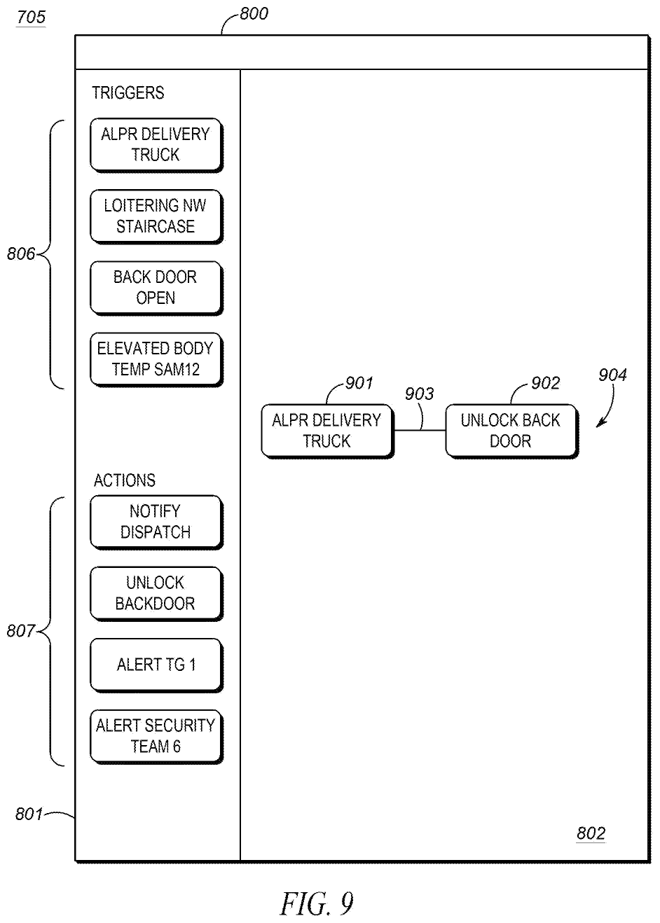

As shown in FIG. 9, which depicts the dashboard 800 in use, a trigger “ALPR delivery truck” 901 has been associated with an action “unlock back door” 902 by dragging a line 903 between the two, thereby forming a workflow 904. While only one trigger 901 and one action 902 is depicted in the workflow 904, the workflow 904 may comprise any suitable number of triggers (e.g. a trigger group) and any suitable numbers of associated actions (e.g. an action group). Hence, if any of the triggers within a trigger group occurs, the workflow 904 is initiated causing the action to be executed. For example, as depicted ALPR stands for automated license plate reader, which may be one of the IoT devices 163; as such, according to the workflow 904, when automated license plate reader of the access control system 160 “reads” a license plate of a delivery truck (e.g. the trigger 901), an associated backdoor (e.g. of a warehouse) is opened; such a backdoor may also comprise one of the IoT devices 163. While note depicted, a memory in the system 100 may also store a list of license plates for which the backdoor is to be opened and the trigger 901 may include comparing a number of the license plate that is read with license plates in such a list, such that the backdoor is opened only when the license plate is on the list.

Furthermore, it is understood that the system 100 may comprise a plurality of IoT devices 163 that are automated license plate reader, and that the trigger 901 may be for a particular automated license plate reader; as such, while not depicted, the actions 807 may include respective “ALPR” actions 807 for other automated license plate reader. Similarly, it is understood that the system 100 may comprise a plurality of IoT devices 163 that are backdoors, and that the action 902 may be for a particular backdoor; as such, while not depicted, the actions 807 may include respective “Unlock Backdoor” actions 807 for other backdoors.

For example, as depicted the triggers 806 include a trigger for detecting loitering at a particular “North West” (e.g. NW) staircase of a particular building (e.g. “Loitering NW Staircase”) that may be detected using a VAE 143 of one or more cameras 142 and the like. The triggers 806 further includes a trigger for detecting whether a particular backdoor is open (e.g. “Backdoor Open”) that may be detected using a VAE 143 of one or more cameras 142 and/or an open/closed sensor on the backdoor and the like. The triggers 806 further includes a trigger for detecting whether a particular individual, for example a first responder and/or police officer and/or security guard having an identifier “SAM12” has an elevated body temperature (e.g. “Elevated Body Temp SAM12”) that may be detected using a biometric sensor of one or more sensors 138 and the like.

For example, as depicted the actions 807 include an action for notifying a first responder and/or police and/or security dispatch (e.g. “Notify Dispatch”) such as the dispatch center 131. The actions 807 further includes an action for alerting a particular talkgroup identified by the identifier TG1 and/or Talkgroup #1 (e.g. “Alert TG1”) such as a particular talkgroup of the radios 137 (and/or the radios 153). The actions 807 further includes an action for alerting a particular security team identified by the identifier Security Team 6 (e.g. “Alert Security Team 6”) which may be associated with a particular group of the radios 137 (and/or the radios 153) and which may, or may not, be associated via a talkgroup.

However, the triggers 806 and actions 807 may include any suitable triggers and actions, which may be dragged and dropped, and the like, into the workspace 802, and associated with each other to generate workflows.

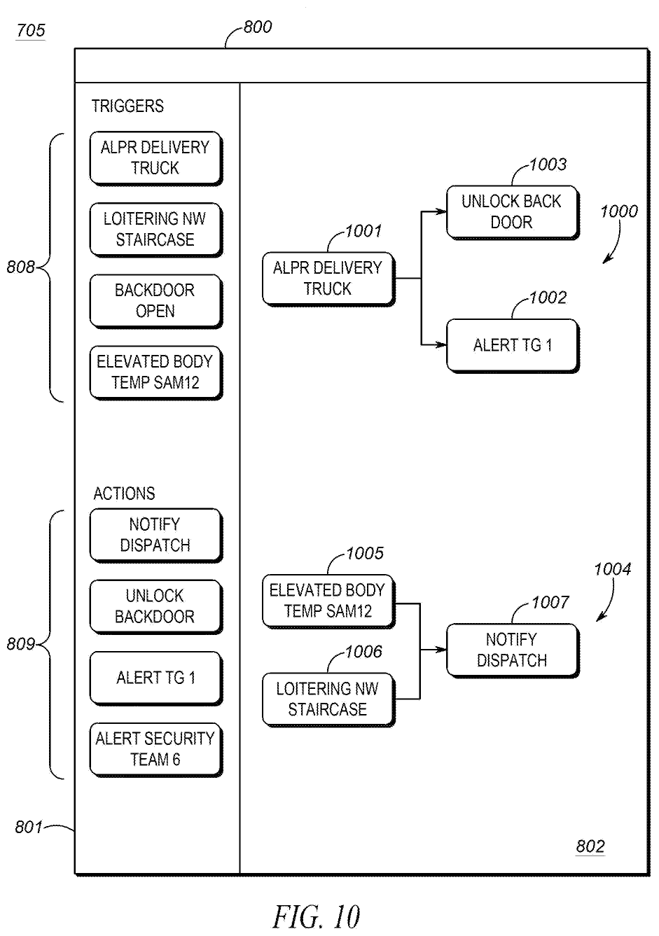

As illustrated in FIG. 10, a single trigger may be associated with multiple actions in a workflow. Thus, in an illustrated workflow 1000, a trigger 1001 of “ALPR delivery truck” may be associated with an action 1003 of “Unlock Back Door” 1003 as well as associated with an action 1002 of “Alert TG 1”. When the workflow 1000 is uploaded to the workflow server 102, and the automatic license plate detects a delivery truck, workflow server 102 will cause both the back door to unlock and an alert to be sent on Talkgroup #1.

In a similar manner multiple triggers may be associated with a single action. Thus, in an illustrated workflow 1004, both a trigger 1005 of “Elevated Body Temp SAM 12” and a trigger 1006 of “Loitering NW Staircase” will cause an action 1007 of “Notify Dispatch” 1008. When the workflow 1004 is uploaded to the workflow server 102, the workflow server 102 notifies the dispatch center when either a police officer (and the like) identified by the identifier “SAM 12” has an elevated body temperature (e.g., above a threshold body temperature), or when loitering is detected in the NW staircase.

As mentioned above, there is a need to automatically update previously generated workflows associated a user (e.g., a security guard assigned to monitor Gate A at a building facility) when the user physically moves to or is assigned to a new location (e.g., there is a change in the security guard's assignment from Gate A to Gate B at the same building facility or a different building facility). However since not all physical devices (i.e., sensors and effectors) assigned to the user for execution of workflows at the previous location may be available or capable of executing same or similar triggers or actions (executed at the previous location) at the new location, there is a further need to automatically identify and configure such physical devices, i.e., sensors available at the new location and capable to execute same or similar triggers (i.e., triggers included in the workflow associated with the user at the previous location) and effectors that are available at the new location and capable to execute same or similar actions (i.e., actions included in the workflow associated with the user at the previous location). Embodiments described herein provide a process 1100 (see FIG. 11) for the workflow server 102 to update workflows associated with a user based on physical devices available for execution of the workflow associated with the user in response to a change in the user's location. Hereafter, it is understood that any of the devices described herein including sensors 138, cameras 142, IoT devices 163, and the like constitute physical devices or sensors that may generate sensor data (e.g., data capturing a predefined environmental condition) for detecting and executing a trigger. Further, it is to be understood that any of the devices described herein including radios 137, flashlights, speakers, sirens, displays, and the like constitute physical devices or effectors that may generate effector data (e.g., indicating an occurrence of a physical condition at the user's current location) for executing an action responsive to the detected trigger.

Turning now to FIG. 11, a flowchart diagram illustrates a process 1100 for updating workflows associated with a user. While a particular order of processing steps, message receptions, and/or message transmissions is indicated in FIG. 11 as an example, timing and ordering of such steps, receptions, and transmissions may vary where appropriate without negating the purpose and advantages of the examples set forth in detail throughout the remainder of this disclosure. A workflow server 102 shown in FIGS. 1-8, and embodied as a singular computing device or distributed computing device may execute process 1100 via an electronic processor 603 shown in FIG. 6.

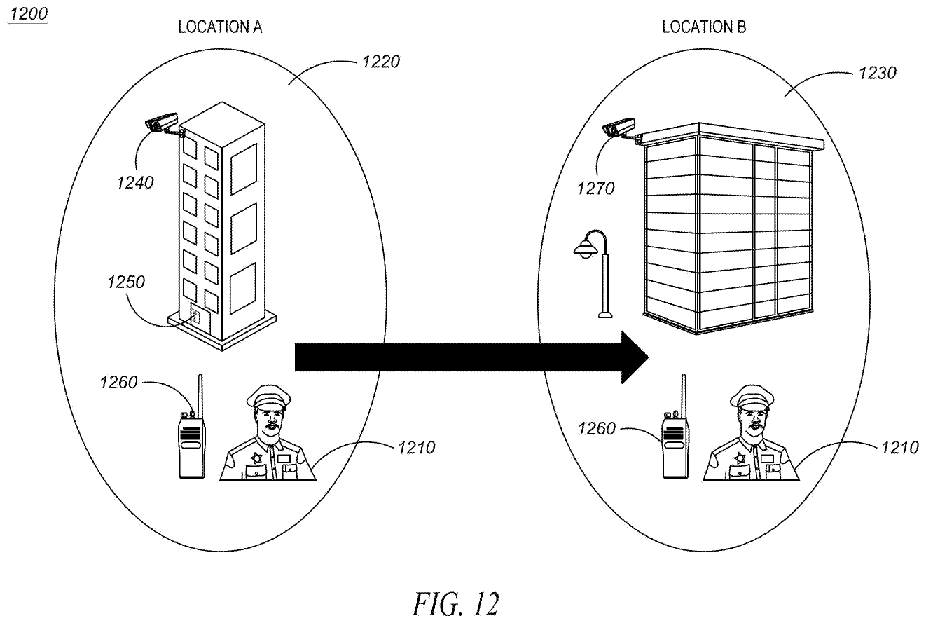

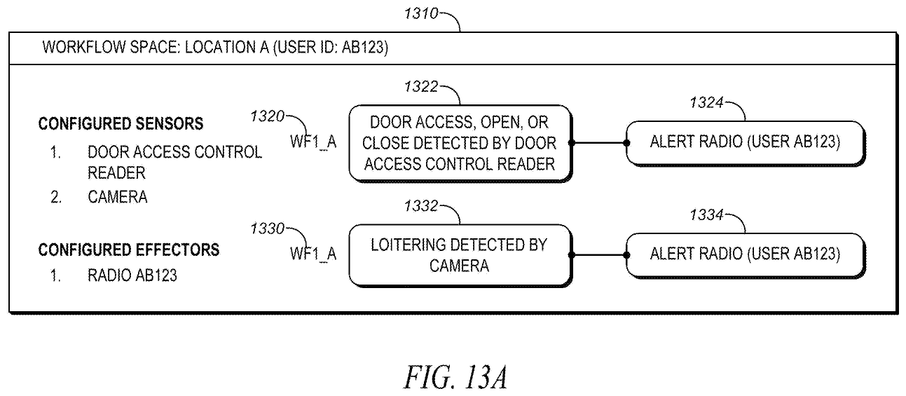

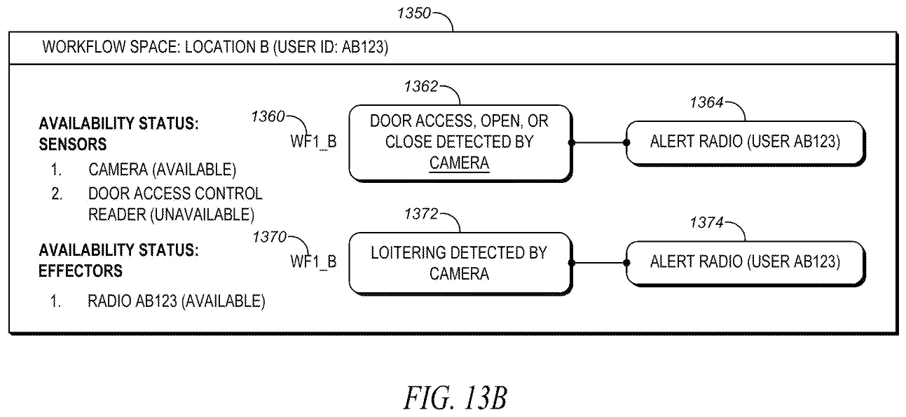

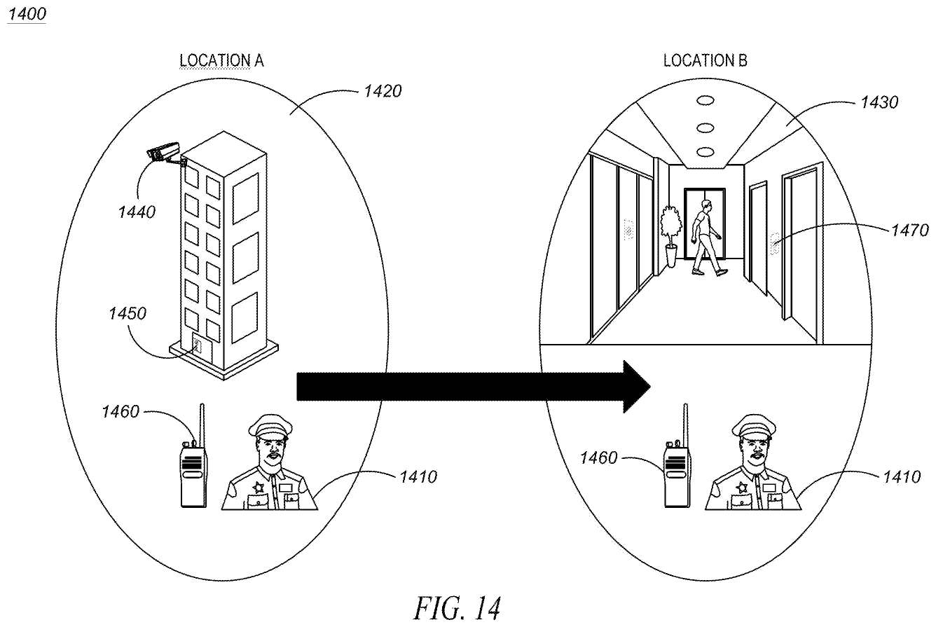

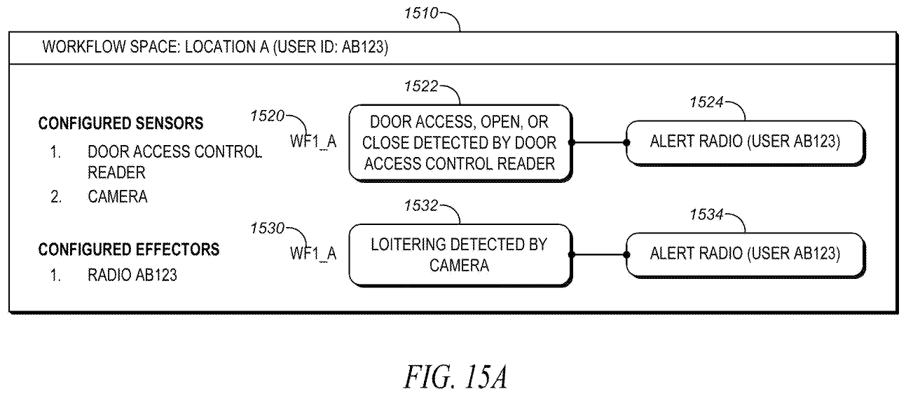

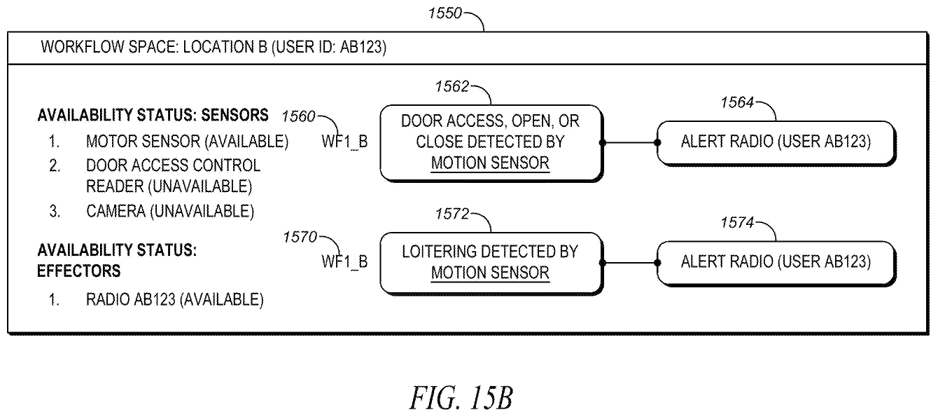

The process 1100 of FIG. 11 need not be performed in the exact sequence as shown and likewise various blocks may be performed in different order or alternatively in parallel rather than in sequence. The process 1100 may be implemented on variations of the security ecosystems shown in FIGS. 1-5 as well. The process 1100 will be described below with reference to an example scenario shown in FIGS. 12, 14 and example workflow dashboards shown in FIGS. 13A, 13B, 15A, and 15B.

At block 1110, the workflow server 102 maintains a workflow associated with a user. As an example, the user may be a security personnel assigned to monitor one or more assigned locations. The workflow associated with the user includes a trigger and a responsive action that are executed while the user is assigned to or physically present at a first location (e.g., a street address of a first building facility). As used herein, the term “workflow associated with a user” represents a workflow particularly created for the user to enable the user to perform a security function using one or more physical devices assigned to the user so long as the user is assigned to or physically present at a particular location (e.g., first location) mapped to the workflow. Also, the term “location” may represent one or more of: a street address, a landmark, name of a building facility, a floor or other structure in a building facility, a location coordinate, or a geographical area or a geofence thereof. In one embodiment, multiple workflows may be associated with the same user while the user is assigned to or physically present at the first location. The workflows including the triggers and actions may be stored at one or more storage components 602, 702 that are accessible to the workflow server 102.

In accordance with some embodiments, a workflow associated with the user includes a trigger (e.g., trigger 806 or 808) and a responsive action (e.g., action 807 or 809) that are respectively executed by a first physical device and a second physical device while the user is assigned to or physically present at a first location. The first physical device includes a sensor configured to detect a predefined environmental condition (e.g., loitering event) at the first location and in response execute the trigger by transmitting a signal indicating an occurrence of the predefined environmental condition at the first location to the second physical device. The sensor may include one or more of a camera sensor, an audio sensor, a vibration sensor, a smell sensor, a motion sensor, a temperature sensor, an ultrasound sensor, a biometric sensor, a tactile sensor, a pressure sensor, an accelerometer sensor, thermal sensor, LiDAR (laser imaging, detection, and ranging) sensor, and the like. The second physical device includes an effector configured to receive the signal from the first physical device and in response execute the action, for example, by providing a visual or non-visual notification indicating the occurrence of the predefined environmental condition at the first location to the user. The effector may include one or more of: a radio, a mobile device, a display, a speaker, a siren, a flashlight, an earpiece accessory, or any other electronic device capable of generating a visual or non-visual output for the user.

For example, in the example scenario 1200 shown in FIG. 12, a user 1210 (e.g., a police officer) is assigned to patrol a first location 1220 (Location A) in which physical devices including sensors (e.g., a camera 1240, an access control reader 1250) and an effector (e.g., radio 1260) are deployed for execution of one or more workflows associated with the user 1210 at the first location 1220. FIG. 13A depicts a dashboard 1310 illustrating workflows 1320, 1330 that are already associated with the user 1210 for execution at the first location 1220 (i.e., Location A). The dashboard 1310 may also provide information identifying a list of configured physical devices (i.e., sensors and effectors) that are being utilized for executing the workflows 1320, 1330 at the first location 1220. The workflow 1320 includes a trigger 1322 executed by the access control reader 1250, for example, by detecting a predefined environmental condition indicative of whether a door at the first location 1220 is accessed, opened, or closed. The workflow 1320 further includes an action 1324 executed by the radio 1260 in response to the trigger 1322. The action 1324 includes alerting the radio 1260 (e.g., a radio operated by a user 1210 with a user identifier ‘AB123’) by generating a visual or non-visual notification on the radio 1260 indicating whether the door was accessed, opened, or closed at the first location 1220. The user 1210 is also associated with a second workflow 1330 that includes a trigger 1332 executed by the camera 1240, for example, by detecting a predefined environmental condition such as a loitering event at the first location 1220. The workflow 1330 also includes an action 1334 executed by the radio 1260 in response to the trigger 1332. The action 1334 includes alerting the radio 1260 by generating a visual or non-visual notification on the radio 1260 indicating an occurrence of a loitering event at the first location 1220.

At block 1120, the workflow server 102 detects that the user has been assigned to or physically present at a second location different from the first location. For example, the scenario 1200 shown in FIG. 12 illustrates a change in user's location from the first location 1220 (e.g., a building facility at ‘Location A’) to the second location 1230 (e.g., a building facility at ‘Location B’). As used herein, the term “change in user's location” represents either a change in user's assigned location or a change in user's physical location. The workflow server 102 may detect a change in user's location in multiple ways. For example, the workflow server 102 may periodically receive records (e.g., from a computer aided dispatch server) including an incident location (e.g., Location B) to which the user 1210 has been dispatched. In this case, the workflow server 102 may compare the incident location (i.e., second location or Location B) to the first location (i.e., Location A) at which the user's workflow (e.g., workflow 1320) is executed. If the incident location or second location is different from the first location, then the workflow server 102 determines that there has been a change in the user's assigned location. As another example, the workflow server 102 may be authorized to track locations of the user 1210, for example, by periodically receiving information indicating a current location of the user 1210 from the radio (e.g., a radio 1260 operated by the user 1210) or other location tracking device operated or worn by the user 1210. In this example, if the user's current location (e.g., second location or Location B) is different from the user's first location (i.e., Location A), then the workflow server 102 determines that the user 1210 is no longer physically present at the first location. Other ways of detecting the user's change in location (i.e., assigned location or physical presence location) exist as well.

In one embodiment, a workflow associated with the user remains unchanged while the user remains assigned to the first location (e.g., a first building facility at Location A). The workflow is automatically disabled by the workflow server 102 (i.e., trigger and responsive actions are not executed) when the user is no longer assigned to the first location. In this embodiment, the workflow associated with the user may be updated by the workflow server 102 when the user's assignment changes to a second location (e.g., a second building facility at Location B). In another embodiment, the workflow associated with the user remains unchanged while the user remains physically present (e.g., within a geofence relative to a first building facility at Location A) at the first location. The workflow is automatically disabled when the user is no longer physically present at the first location. In this embodiment, the workflow associated with the user may be updated by the workflow server 102 when the user's physical presence changes to a second location (e.g., a second building facility at Location B). In a further embodiment, the workflow associated with the user remains unchanged even after the user's assignment or physical presence changes to a second location provided the physical devices (i.e., sensors and effectors) respectively executing the trigger and action of the workflow continue to be available to the user for execution of the workflow at the second location.

In any case, when the workflow server 102 detects that the user has been assigned to or physically present at a second location different from the first location, the workflow server 102 proceeds to block 1130 to determine whether the first and second physical devices (that are assigned to the user for executing the workflow at the first location) are available for executing the workflow associated with the user at the second location. For example, referring to FIGS. 12 and 13A, with respect to the workflow 1320, the workflow server 102 determines whether the access control reader 1250 is available for executing the trigger 1322 associated with the workflow 1320. In this case, the workflow server 102 may access a device list indicative of a list of devices available for executing workflows corresponding to the second location 1230. If the device list does not include an identifier of the access control reader 1250 or another access control reader that can execute a trigger function (e.g., detecting a door being accessed, opened, or closed) similar to the trigger 1322 at the second location 1230, then the workflow server 102 may determine that an access control reader is no longer available for executing the workflow 1320 associated with the user 1210 at the second location 1230. In one embodiment, even if the device list indicates availability of an access control reader that can execute the trigger 1322 at the second location 1230, the workflow server 102 may still determine that the access control reader is not available for executing the workflow 1320 at the second location 1230 when the user 1210 is not authorized to use or access the access control reader at the second location 1230 for executing a corresponding trigger action at the second location 1230. The workflow server 102 further determines whether the radio 1260 is available for executing the action 1324 associated with the workflow 1320. The workflow server 102 may similarly access a device list indicative of a list of devices available for executing workflows corresponding to the second location 1230. In this case, the workflow server 102 may determine, from the device list, that the radio 1260 remains assigned to (and/or being operated by) the user 1210 at the second location 1230 and that the radio 1260 continues to be available for executing a same or similar workflow function (i.e., action 1324) corresponding to the workflow 1320 associated with the user 1210 at the second location 1230.

Accordingly, with respect to the example workflow 1320 shown in FIG. 13A, the workflow server 102 may determine that a physical device (i.e., access control reader 1250) selected from one of the first physical device (i.e., access control reader 1250) and the second physical device (i.e., radio 1260) is no longer available for executing a same or similar workflow function (i.e., trigger 1332) corresponding to the workflow 1320 at the second location 1230. As used herein, the term “selected physical device” represents a physical device (e.g., access control reader 1250) which has executed a workflow function (e.g., trigger 1322) for a user (e.g., user 1210) at a previous location (e.g., Location A or first location 1220), but is no longer available for executing a same or similar workflow function (e.g., trigger 1322) for the user at a new location (e.g., Location B or second location 1230). In accordance with some embodiments, when one or more physical devices executing a trigger or responsive action associated with the user's workflow is no longer available for execution at a new location, the workflow server 102 further executes blocks 1140, 1150, and 1160 to determine if an alternative physical device is available for executing a same or similar workflow function at the second location and to further generate and implement an updated workflow for the user based on the availability of the alternative physical device.

At block 1140, the workflow server 102 identifies a third physical device that is (i) available to be assigned to the user for execution of the workflow associated with the user at the second location and (ii) capable of executing a workflow function at the second location, where the workflow function corresponds to one of the trigger or responsive action executed by the selected physical device at the first location. The third physical device may be of a device type similar to or different from that of the selected physical device.

If the selected physical device (i.e., a physical device which is no longer available for executing a workflow function at the user's second location) is the first physical device executing the trigger at the first location, then the workflow server 102 identifies a third physical device (also referred to as an alternative physical device) by first determining that each physical device included in a set of physical devices available to be assigned to the user for execution of the workflow at the second location is of a device type different from that of the first physical device. The workflow server 102 then selects the third physical device from the set of physical devices upon determining that the third physical device is capable of executing a similar workflow action corresponding to the trigger at the second location.

In one embodiment, if the selected physical device includes a sensor (e.g., a camera sensor) capable of executing a trigger by detecting a predefined environmental condition (e.g., loitering event) using visual sensor data (e.g., image or video data) captured corresponding to the first location, then the workflow server 102 identifies the third physical device as follows. The workflow server 102 determines that a set of physical devices available to be assigned to the user for execution of the trigger at the second location does not include a sensor that is capable of capturing visual data for detecting the predefined environmental condition at the second location. The workflow server 102 then selects the third physical device from the set of physical devices available to the be assigned to the user upon determining that the third physical device includes a sensor (e.g., a non-camera sensor such as a motion sensor) that is capable of executing the workflow function corresponding to the trigger by detecting the same environmental condition (e.g., loitering event) using non-visual data (e.g., motion data) captured corresponding to the second location.

In another embodiment, if the selected physical device includes a sensor (e.g., a non-camera sensor such as a motion sensor) capable of executing a trigger by detecting a predefined environmental condition (e.g., loitering event) using non-visual data (e.g., motion data) captured corresponding to the first location, then the workflow server 102 identifies the third physical device as follows. The workflow server 102 determines that a set of physical devices available to be assigned to the user for execution of the trigger at the second location does not include a sensor that is capable of capturing non-visual data for detecting the predefined environmental condition at the second location. The workflow server 102 then selects the third physical device from the set of physical devices available to the be assigned to the user upon determining that the third physical device includes a sensor (e.g., a camera sensor) that is capable of executing the workflow function corresponding to the trigger by detecting the same environmental condition (e.g., loitering event) using visual data (e.g., image or video data) captured corresponding to the second location.

For example, with respect to the scenario shown in FIG. 12 and a corresponding workflow 1320 shown in FIG. 13A, since the access control reader 1250 is no longer available for executing a workflow function corresponding to trigger 1322, the workflow server 102 proceeds to identify an alternative physical device that can perform a similar workflow function (i.e., detecting a door being accessed, opened, or closed) corresponding to trigger 1322. In the example shown in FIG. 12, the workflow server 102 identifies a camera 1270 that is available to be assigned to the user 1210 for execution of a workflow function corresponding to the trigger 1322 associated with the user 1210 at the second location 1230. The workflow server 102 also determines that the camera 1270, which is of a device type different from an access control reader, is capable of executing a workflow function corresponding to the trigger 1322) at the second location 1230. Before identifying the camera 1270 as an alternative physical device, the workflow server 102 accesses a device list identifying a set of physical devices or sensors that are available for assignment to the user for executing a workflow function corresponding to the trigger 1322 at the second location 1230. If the device list identifies at least one physical device which is of the same device type (i.e., an access control reader performing an access control function) as the access control reader 1250 (i.e., a selected physical device which is no longer available for execution at the user's new location), then the workflow server 102 may select a third physical device (also referred to as an alternative physical device) that is of the same type as the access control reader 1250. On the other hand, if each physical device included in the device list is of a device type different from that of the access control reader 1250, then the workflow server 102 selects a third physical device (e.g., camera 1270) that performs a similar function (e.g., detecting doors being accessed, opened, or closed) as the access control reader 1250. In accordance with some embodiments, the workflow server 102 may further access a device capability list indicative of a list of device capabilities corresponding to a particular physical device. In this example, the workflow server 102 may determine that the camera 1270 is capable of executing a workflow function corresponding to the trigger 1322 because camera's device capabilities indicates that the camera 1270 has a field of view to an area where the door is placed and can further process captured images to determine whether the door is accessed, opened, or closed.

If the selected physical device (i.e., a physical device which is no longer available for executing a workflow function at the user's second location) is the second physical device executing the responsive action at the first location, then the workflow server 102 identifies a third physical device (also referred to as an alternative physical device) by first determining that each physical device included in a set of physical devices available to be assigned to the user for execution of the workflow at the second location is of a device type different from that of the first physical device. The workflow server 102 then selects the third physical device from the set of physical devices upon determining that the third physical device is capable of executing a similar workflow action corresponding to the responsive action at the second location.

In one embodiment, if the selected physical device includes an effector (e.g., an electronic display) capable of executing a responsive action by presenting a visual output indicating an occurrence of a predefined environmental condition (e.g., loitering event) at the first location to a user, then the workflow server 102 identifies the third physical device as follows. The workflow server 102 determines that a set of physical devices available to be assigned to the user for execution of the responsive action at the second location does not include an effector that is capable of rendering visual data indicating an occurrence of the predefined environmental condition at the second location. The workflow server 102 then selects the third physical device from the set of physical devices available to the be assigned to the user upon determining that the third physical device includes an effector (e.g., an electronic speaker or a siren) that is capable of executing the workflow function corresponding to the responsive action by providing a non-visual output (e.g. audio or tactile output) indicating an occurrence of the same environmental condition (e.g., loitering event) at the second location to the user.

In another embodiment, if the selected physical device includes an effector (e.g., an electronic speaker or a siren) capable of executing a responsive action by providing a non-visual output (e.g., audio or tactile output) indicating an occurrence of a predefined environmental condition (e.g., loitering event) at the first location to a user, then the workflow server 102 identifies the third physical device as follows. The workflow server 102 determines that a set of physical devices available to be assigned to the user for execution of the responsive action at the second location does not include an effector that is capable of providing a non-visual output indicating an occurrence of the predefined environmental condition at the second location. The workflow server 102 then selects the third physical device from the set of physical devices available to the be assigned to the user upon determining that the third physical device includes an effector (e.g., an electronic display) that is capable of executing the workflow function corresponding to the responsive action by rendering a visual output indicating an occurrence of the same environmental condition (e.g., loitering event) at the second location to the user.

In any case, when the workflow server 102 identifies a third physical device that is capable of executing a workflow function corresponding to either a trigger or a responsive action, the workflow server 102 proceeds to block 1150 to update the workflow associated with the user by replacing the selected physical device indicated in the workflow with the third physical device. In accordance with embodiments, the workflow server 102 updates the workflow by including, in the updated workflow, information indicating that the trigger is executed by the selected physical device and the responsive action is executed by the second physical device while the user is assigned to or physically present at the second location. For example, referring to FIG. 13B, a dashboard 1350 illustrates updates made to the workflows 1320, 1330 associated with the user 1210 based on a change in the user's location from the first location 1220 to the second location 1230. In the dashboard 1350, a workflow 1360 is shown including a trigger 1362 and a responsive action 1364. The workflow 1360 is generated by the workflow server 102 for execution at the second location while the user 1210 is assigned to or physically present at the second location 1230. The workflow 1360 is generated by updating a corresponding workflow 1320 previously executed at the user's first location 1220. More particularly, since the workflow server 102 has identified, at block 1140, that the camera 1240 is available as well as capable of performing a workflow function (i.e., detecting a door being accessed, opened, or closed) similar to the trigger 1332, the workflow server 102 generates a trigger 1362 by replacing the term “door access control reader” included in the trigger 1332 with the term “camera” as shown in FIG. 13B. The action 1364 shown in FIG. 13B is included in the updated workflow 1360 without any changes to the information included in the corresponding action 1324 shown in FIG. 13A because the radio 1260 continues to be available to the user 1210 for execution of the same workflow action (i.e., alerting the radio 1260) at the second location 1230.

At block 1160, the workflow server 102 implements the updated workflow by transmitting a command instructing the third physical device to execute the workflow function corresponding to the one of the trigger or responsive action at the second location. For example, referring to FIG. 13B, after the workflow server 102 generates an updated workflow 1360 associated with the user 1210 for execution at the second location 1230, the workflow server 102 may render a dashboard 1350 on a display screen (e.g., display screen 705) to show the updated workflow. In one embodiment, the workflow server 102 implements the updated workflow 1360 only after receiving an input indicating that the user 1210 (or a workflow administrator) has approved the updated workflow shown on the dashboard 1350. In the example shown in FIG. 13B, the workflow server 102 implements the updated workflow 1360 by transmitting a command instructing the camera 1240 to execute a workflow function (i.e., detecting a door being accessed, opened, or closed) corresponding to the trigger 1322 at the second location 1230.

In accordance with some embodiments, the workflow server 102 may also transmit a further command instructing the selected physical device (i.e., a device which executed a workflow function prior to it being replaced by the third physical device) to stop execution of the workflow action corresponding to the one of the trigger or responsive action at the second location. For example, referring to FIGS. 12 and 13, since the access control reader 1250 is no longer available for executing a workflow function corresponding to the trigger 1322 for the user 1210 at the second location 1230, the workflow server 102 may instruct the access control reader 1250 to stop execution of the corresponding trigger 1322 at the first location 1220. In accordance with some embodiments, the workflow server 102 continues to track a change in user's assigned location or physical presence location. For example, when the workflow server 102 determines that the user 1210 is no longer assigned to or physically present at the second location 1230, the workflow server 102 transmits a further command instructing the third physical device (i.e., camera 1270) to stop execution of a workflow function corresponding to the trigger 1362 at the second location 1230 unless the user is assigned to or physically present at a third location at which the camera 1270 continues to be available for executing a same or similar workflow function corresponding to the trigger 1362 at the third location.

In accordance with some embodiments, one or more workflows generated for the user at the second location (i.e., in response to the change in the user's assigned location or physical presence location) may remain unchanged relative to the corresponding workflows previously executed for the user at the first location. Referring to FIG. 13A, the dashboard 1310 shows a further workflow 1330 that is executed for the user 1210 at the first location 1220. The workflow 1330 includes a trigger 1332 executed by the camera 1240 deployed at the first location 1220. The trigger 1332 is executed by the camera 1240 upon detecting a loitering event at the first location 1220. The workflow 1330 also includes an action 1334 executed by the radio 1260 in response to the trigger 1332. The action 1334 includes alerting the radio 1260 by generating a visual or non-visual notification on the radio 1260 indicating an occurrence of a loitering event at the first location 1220. The workflow 1330 is executed by the physical devices including a camera 1240 (operating as a sensor) and a radio (operating as an effector) as long as the user's assigned location or physical presence location is the first location 1220. When the workflow server 102 detects that there has been a change in the user's assigned location from a first location 1220 (i.e., Location A) to a second location 1230 (i.e., Location B) as shown in FIG. 12, the workflow server 102 generates an updated workflow 1370 as shown in the dashboard 1350 of FIG. 13B. In this example, with respect to the workflow 1330 executed at the first location 1220, the workflow server 102 has generated a corresponding workflow 1370 for execution at the second location 1230. The workflow 1370 includes a trigger 1372 and a responsive action 1374. The information (i.e., indicating a particular workflow function to be performed and a particular physical device which should perform the workflow function) included in both the trigger 1372 and the responsive action 1364 associated with the workflow 1370 remains unchanged relative to the information included in the trigger 1332 and the action 1334 associated with the workflow 1330. There is no change in information in the trigger 1372 and responsive action 1364 associated with the workflow 1370 because the workflow server 102 has identified an available physical device (i.e., camera 1270 deployed at the second location 1230) which is of same device type as the physical device (i.e., a camera 1240 deployed at the first location 1220) which previously executed a workflow function corresponding to the trigger 1332 at the first location 1220. In one embodiment, even though there is no change in the information (when compared to the workflow 1330) in the newly generated workflow 1370, the workflow server 102 may still need to transmit a command instructing the camera 1270 deployed at the second location 1230 to execute a workflow function (i.e., executing trigger 1332 upon detecting a loitering event at the second location 1230) for the user 1210 at the second location 1230.

In accordance with some embodiments, the workflow server 102 may generate a new workflow in response to a change in user's assigned location or physical presence location, such that, the new workflow may include an updated trigger or action that is executed by a physical device that is of a device type different than a physical device which executed the similar trigger or action at the user's previous location. For example, a physical device which executed a trigger (e.g., loitering event) at the user's previous location may be a visual sensor (e.g., a camera) whereas a physical device which is available for executing the same trigger at the user's new location may be a non-visual sensor (e.g., a motion sensor). Similarly, a physical device which executed a trigger (e.g., loitering event) at the user's previous location may be a non-visual sensor (e.g., a motion sensor) whereas a physical device which is available for executing the same trigger at the user's new location may be a visual sensor (e.g., a camera). As another example, a physical device which executed a responsive action (e.g., notify the loitering event) at the user's previous location may be a visual effector (e.g., an electronic display) whereas a physical device which is available for executing the same trigger at the user's new location may be a non-visual effector (e.g., a siren). Similarly, a physical device which executed the action (e.g., notify the loitering event) at the user's previous location may be a non-visual effector (e.g., an electronic speaker) whereas a physical device which is available for executing the same trigger at the user's new location may be a visual effector (e.g., a floodlight).

Now referring to FIG. 14, a second example scenario 1400 is shown to illustrate the process 1100 for updating workflows associated with a user 1410. The user 1410 (e.g., a police officer) is assigned to patrol a first location 1420 (Location A) in which physical devices including sensors (a camera 1440, an access control reader 1450) and an effector (e.g., a radio 1460) are deployed for execution of one or more workflows associated with the user 120 at the first location 1420.

FIG. 15A depicts a dashboard 1510 illustrating workflows 1520, 1530 that are already associated with the user 1410 for execution at the first location 1420 (i.e., Location A). The dashboard 1310 may also provide information identifying a list of configured physical devices (i.e., sensors and effectors) that are being utilized for executing the workflows 1520, 1530 at the first location 1420. The workflow 1520 includes a trigger 1522 executed by the access control reader 1450, for example, by detecting a predefined environmental condition indicative of whether a door at the first location 1420 is accessed, opened, or closed. The workflow 1520 further includes an action 1524 executed by the radio 1460 in response to the trigger 1522. The action 1524 includes alerting the radio 1460 (e.g., a radio operated by a user 1410 with a user identifier ‘AB123’) by generating a visual or non-visual notification on the radio 1460 indicating whether the door was accessed, opened, or closed at the first location 1420. The user 1410 is also associated with a further workflow 1530 that includes a trigger 1532 executed by the camera 1440, for example, by detecting a predefined environmental condition such as a loitering event at the first location 1420. The workflow 1530 also includes an action 1534 executed by the radio 1460 in response to the trigger 1532. The action 1534 includes alerting the radio 1460 by generating a visual or non-visual notification on the radio 1460 indicating an occurrence of a loitering event at the first location 1420.

In accordance with embodiments, the workflow server 102 tracks changes in user's assigned or physical presence locations to determine if there is a need to update workflows associated with the user. In the example scenario shown in FIG. 14, the user 1410 has changed his location from the first location 1420 (e.g., a building facility at ‘Location A’) to a second location 1430 (e.g., a building facility at ‘Location B’). Accordingly, the workflow server 102 executes the process 1100 (more particularly, block 1130) to determine whether there is a need to update workflows 1520, 1530 associated with the user 1410 in order to create corresponding workflows for execution at the second location 1430. With respect to the example workflow 1520 in FIG. 14A, the workflow server 102 may determine that a physical device (i.e., an access control reader 1450) executing the trigger 1522 is no longer available for executing a workflow function corresponding to the trigger 1522 at the second location 1430. Similarly, with respect to the example workflow 1530 shown in FIG. 14A, the workflow server may determine that a physical device (i.e., a camera 1440) executing the trigger 1532 is no longer available for executing a workflow function corresponding to the trigger 1532 at the second location 1430. In this case, the workflow server 102 needs to identify one or more alternative physical devices that are available to be assigned to the user 1410 for executing a workflow function corresponding to the triggers 1522, 1532 at the second location 1430. In the example shown in FIG. 14, the workflow server 102 may determine that a motion sensor 1470 deployed at the second location 1430 is capable of executing a workflow function (i.e., detecting whether a door is accessed, closed, or opened) corresponding to the trigger 1522 which was previously executed by the access control reader 1450 deployed at the first location 1420. The workflow server 102 may further determine that the motion sensor 1470 deployed at the second location 1430 is capable of executing a workflow function (i.e., detecting a loitering event) corresponding to the trigger 1532 which was previously executed by the camera 1440 deployed at the first location 1420.

Now referring to FIG. 15B, a dashboard 1550 illustrates updates made to the workflows 1520, 1530 associated with the user 1410 based on a change in the user's location from the first location 1420 to the second location 1430. The workflow server 102 may generate updated workflows 1560, 1570 in accordance with block 1150 of the process 1100 shown in FIG. 13. In the dashboard 1550, a workflow 1560 is shown including a trigger 1562 and a responsive action 1564. The workflow 1560 is generated by the workflow server 102 for execution at the second location while the user 1410 is assigned to or physically present at the second location 1230. The workflow 1560 is generated by updating a corresponding workflow 1520 previously executed at the user's first location 1420. More particularly, since the workflow server 102 has identified that the motion sensor 1470 is available as well as capable of performing a workflow function (detecting a door being accessed, opened, or closed) similar to the trigger 1522, the workflow server 102 generates a trigger 1562 by replacing the term “door access control reader” included in the trigger 1522 with the term “motion sensor” as shown in FIG. 15B. Similarly, the workflow 1570 is generated by updating a corresponding workflow 1530 previously executed at the user's first location 1420. More particularly, since the workflow server 102 has identified that the motion sensor 1470 is available as well as capable of performing a workflow function (detecting a loitering event) similar to the trigger 1532, the workflow server 102 generates a trigger 1572 is generated by replacing the term “camera” included in the trigger 1532 with the term “motion sensor” as shown in FIG. 15B. The actions 1564, 1574 shown in FIG. 13B are included in the respectively updated workflows 1560, 1570 without any changes to the information included in the corresponding actions 1524, 1534 shown in FIG. 15A because the radio 1460 continues to be available for execution of the same workflow action (i.e., alerting the radio 1460) at the second location 1230.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of updating workflows associated with a user, the method comprising:
maintaining, at a workflow server, a workflow associated with the user, the workflow indicating that a trigger and a responsive action are respectively executed on a first physical device and a second physical device while the user is assigned to or physically present at a first location;
detecting, at the workflow server, that the user has been assigned to or physically present at a second location different from the first location and responsively determining that a physical device selected from one of the first physical device and the second physical device is no longer available for executing the workflow associated with the user at the second location;
identifying, at the workflow server, a third physical device that is (i) available to be assigned to the user for execution of the workflow associated with the user at the second location and (ii) capable of executing a workflow function at the second location, the workflow function corresponding to one of the trigger or responsive action executed by the selected physical device at the first location;
updating, at the workflow server, the workflow associated with the user by replacing the selected physical device indicated in the workflow with the third physical device; and
implement, at the workflow server, the updated workflow by transmitting a command instructing the third physical device to execute the workflow function corresponding to the one of the trigger or responsive action at the second location.

2. The method of claim 1, wherein the first physical device includes a sensor configured to detect a predefined environmental condition at the first location and in response execute the trigger by transmitting a signal indicating an occurrence of the predefined environmental condition at the first location to the second physical device.

3. The method of claim 2, wherein the second physical device includes an effector configured to receive the signal indicating the occurrence of the predefined environmental condition at the first location from the first physical device and in response execute the action.

4. The method of claim 1, wherein the third physical device is of a device type different from that of the selected physical device.

5. The method of claim 1, wherein the selected physical device is the first physical device executing the trigger at the first location, wherein identifying the third physical device comprises:
determining that each physical device included in a set of physical devices available to be assigned to the user for execution of the workflow at the second location is of a device type different that of the first physical device; and
selecting the third physical device from the set of physical devices upon determining that the third physical device is capable of executing the workflow function corresponding to the trigger at the second location.

6. The method of claim 1, wherein the selected physical device includes a sensor capable of executing the trigger by detecting a predefined environmental condition using visual sensor data captured corresponding to the first location, wherein identifying the third physical device comprises:
determining that a set of physical devices available to be assigned to the user for execution of the trigger at the second location does not include a sensor that is capable of capturing visual data for detecting the predefined environmental condition at the second location; and
selecting the third physical device from the set of physical devices available to be assigned to the user upon determining that the third physical device includes a sensor that is capable of executing the workflow function corresponding to the trigger by detecting the predefined environmental condition using non-visual data captured corresponding to the second location.

7. The method of claim 6, wherein the sensor included in the selected physical device is a camera sensor and the sensor included in the third physical device is a non-camera sensor.

8. The method of claim 1, wherein the selected physical device is the second physical device executing the responsive action at the first location, wherein identifying the third physical device comprises:
determining that each physical device included in a set of physical devices available to be assigned to the user for execution of the workflow at the second location is of a device type different that of the first physical device; and
selecting the third physical device from the set of physical devices upon determining that the third physical device is capable of executing the workflow function corresponding to the responsive action at the second location.

9. The method of claim 1, wherein the selected physical device includes an effector capable of executing the responsive action by presenting a visual output indicating an occurrence of a predefined environmental condition at the first location to the user, the method comprising:
determining that a set of physical devices available to be assigned to the user for execution of the responsive action at the second location does not include an effector that is capable of rendering a visual output indicating an occurrence of the predefined environmental condition at the second location; and
selecting the third physical device from the set of physical devices available to be assigned to the user upon determining that the third physical device includes an effector that is capable of executing the workflow function corresponding to the responsive action at the second location by providing a non-visual output indicating an occurrence of the predefined environmental condition at the second location to the user.

10. The method of claim 9, wherein the effector included in the second physical device is an electronic display and the effector included in the third physical device is an electronic speaker.

11. The method of claim 1, wherein the second physical device includes an effector capable of executing the responsive action by presenting a non-visual output indicating an occurrence of a predefined environmental condition at the first location to the user, the method comprising:
determining that a set of physical devices available to be assigned to the user for execution of the responsive action at the second location does not include an effector that is capable of providing a non-visual output indicating an occurrence of the predefined environmental condition at the second location; and
selecting the third physical device from the set of physical devices available to be assigned to the user upon determining that the third physical device includes an effector that is capable of executing the workflow function corresponding to the responsive action at the second location by rendering a visual output indicating an occurrence of the predefined environmental condition at the second location to the user.

12. The method of claim 11, wherein the effector included in the second physical device is an electronic speaker and the effector included in the third physical device is an electronic display.

13. The method of claim 1, wherein identifying the third physical device comprises:
determining that the user is authorized to use the third physical device for executing the workflow function corresponding to the one of the trigger or responsive action at the second location.

14. The method of claim 1, further comprising:
determining that the user is no longer assigned to or physically present at the second location; and
transmitting a command instructing the third physical device to stop execution of the workflow function corresponding to the one of the trigger or responsive action at the second location.

15. The method of claim 1, wherein when the selected physical device is the first physical device, wherein updating the workflow comprises:
including, in the updated workflow, information indicating that the trigger is executed by the third physical device and the responsive action is executed by the second physical device while the user is assigned to or physically present at a second location.

16. The method of claim 1, wherein when the selected physical device is the second physical device, wherein updating the workflow comprises:
including, in the updated workflow, information indicating that the trigger is executed on the first physical device and the responsive action is executed on the third physical device while the user is assigned to or physically present at the second location.

17. A workflow server, comprising:
a memory;
a communications interface; and
an electronic processor communicatively coupled to the memory and the communications interface, the electronic processor configured to:
maintain, at a memory, a workflow associated with a user, the workflow indicating that a trigger and a responsive action are respectively executed by a first physical device and a second physical device while the user is assigned to or physically present at a first location;
detect that the user has been assigned to or physically present at a second location different from the first location and responsively determining that a physical device selected from one of the first physical device and the second physical devices is no longer available for executing the workflow associated with the user at the second location;
identify a third physical device that is (i) available to be assigned to the user for execution of the workflow associated with the user at the second location and (ii) capable of executing a workflow function at the second location, the workflow function corresponding to one of the trigger or responsive action executed by the selected physical device at the first location;
update the workflow associated with the user by replacing the selected physical device indicated in the workflow with the third physical device; and
implement the updated workflow by transmitting, via the communications interface, a command instructing the third physical device to execute the workflow function corresponding to the one of the trigger or responsive action at the second location.

18. The workflow server of claim 17, wherein the third physical device is of a device type different from that of the selected physical device.

19. The workflow server of claim 17, wherein the selected device is the first physical device executing the trigger at the first location, wherein the electronic processor is configured to:
determine that each physical device included in a set of physical devices available to be assigned to the user for execution of the workflow at the second location is of a device type different that of the first physical device; and
select the third physical device from the set of physical devices upon determining that the third physical device is capable of executing the workflow function corresponding to the trigger at the second location.

20. The workflow server of claim 17, wherein the selected physical device includes a sensor capable of executing the trigger by detecting a predefined environmental condition using visual sensor data captured corresponding to the first location, wherein the electronic processor is configured to:
determine that a set of physical devices available to be assigned to the user for execution of the trigger at the second location does not include a sensor that is capable of capturing visual data for detecting the predefined environmental condition at the second location; and
select the third physical device from the set of physical devices available to be assigned to the user upon determining that the third physical device includes a sensor that is capable of executing the workflow function corresponding to the trigger by detecting the predefined environmental condition using non-visual data captured corresponding to the second location.
